(19) United States
(12) Patent Application Publication
(10) Pub. No.: US 2025/0047023 A1
(43) Pub. Date: Feb. 6, 2025

(54) Terminal Body, Terminal and Connector

(71) Applicants: Tyco Electronics Technology (SIP) Co., Ltd., Suzhou (CN); Tyco Electronics (Shanghai) Co., Ltd., Shanghai (CN)

(72) Inventors: Weidong Zhang, Shanghai (CN); Jian Wang, Suzhou (CN); Wenzheng Ma, Suzhou (CN); Pengsheng Jiang, Suzhou (CN)

(73) Assignees: Tyco Electronics Technology (SIP) Co., Ltd., Suzhou (CN); Tyco Electronics (Shanghai) Co., Ltd., Shanghai (CN)

(21) Appl. No.: 18/791,840

(22) Filed: Aug. 1, 2024

(30) Foreign Application Priority Data
Aug. 3, 2023 (CN) 202322084905.9

(51) Int. Cl. H01R 13/11; H01R 4/02; H01R 13/428

(52) U.S. Cl. CPC H01R 13/11; H01R 4/029; H01R 13/428

(57) ABSTRACT

A terminal body comprises a first terminal plate having a first mating part and a first welding part connected to the first mating part, and a second terminal plate. The second terminal plate has a second mating part, and a second welding part connected to the second mating part. The first mating part and the second mating part are spaced relative to each other in a height direction of the terminal body to allow for the insertion of a mating terminal. The first welding part is stacked and welded on the second welding part. The first terminal plate and the second terminal plate are two independent components formed separately.

### CROSS-REFERENCE TO RELATED APPLICATION

This application claims the benefit of Chinese Patent Application No. CN202322084905.9 filed on Aug. 3, 2023 in the State Intellectual Property Office of China, the whole disclosure of which is incorporated herein by reference.

### FIELD OF THE INVENTION

Embodiments of the present disclosure relate to a terminal body, a terminal comprising the terminal body and a connector comprising the terminal.

### BACKGROUND

In the prior art, the terminal of a high-voltage connector typically includes a terminal body and a pair of elastic contacts. The terminal body usually includes two terminal plates facing each other and a connecting part connected between sides of the two terminal plates. The pair of elastic contacts are installed on the inner surfaces facing each other of two terminal plates. The elastic contacts clamp a mating terminal inserted between them, in order to achieve electrical connection between the terminal and the mating terminal.

In the prior art, the terminal body is usually an integral stamped piece, and the connecting part between two terminal plates needs to be bent approximately 180 degrees. However, some metal materials, such as aluminum or aluminum alloys, are prone to cracking when bent at large angles, which can reduce the conductivity of the terminal.

### SUMMARY

According to an embodiment of the present disclosure, a terminal body includes a first terminal plate having a first mating part and a first welding part connected to the first mating part, and a second terminal plate. The second terminal plate has a second mating part, and a second welding part connected to the second mating part. The first mating part and the second mating part are spaced relative to each other in a height direction of the terminal body to allow for the insertion of a mating terminal. The first welding part is stacked and welded on the second welding part. The first terminal plate and the second terminal plate are two independent components formed separately.

### BRIEF DESCRIPTION OF THE DRAWINGS

The invention will now be described by way of example with reference to the accompanying Figures, of which:

FIG. 1 shows an illustrative perspective view of a terminal according to an exemplary embodiment of the present invention;

FIG. 2 shows an illustrative exploded view according to an exemplary embodiment of the present invention;

FIG. 3 shows an illustrative assembly view of a first terminal plate and one elastic contact according to an exemplary embodiment of the present invention;

FIG. 4 shows an illustrative exploded view of a first terminal plate and one elastic contact according to an exemplary embodiment of the present invention;

FIG. 5 shows an illustrative assembly view of a second terminal plate and the other elastic contact according to an exemplary embodiment of the present invention; and

FIG. 6 shows a schematic diagram of the disassembly of a second terminal plate and the other elastic contact according to an exemplary embodiment of the present invention.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an aspect of the present disclosure, a terminal body comprises a first terminal plate having a first mating part and a first welding part connected to the first mating part, and a second terminal plate. The second terminal plate has a second mating part and a second welding part connected to the second mating part. The first mating part and the second mating part are spaced relative to each other in a height direction of the terminal body to allow for the insertion of a mating terminal. The first welding part is stacked and welded on the second welding part. The first terminal plate and the second terminal plate are two independent components formed separately.

According to another aspect of the present disclosure, a terminal comprises the above terminal body, and a pair of elastic contacts. The pair of elastic contacts are installed on the inner surfaces facing each other of the first mating part and the second mating part, respectively. The pair of elastic contacts are used to clamp the mating terminal inserted between them, in order to achieve electrical connection between the terminal and the mating terminal. According to yet another aspect of the present disclosure, there is provided a connector. The connector includes a connector housing; and the above terminal inserted into the connector housing.

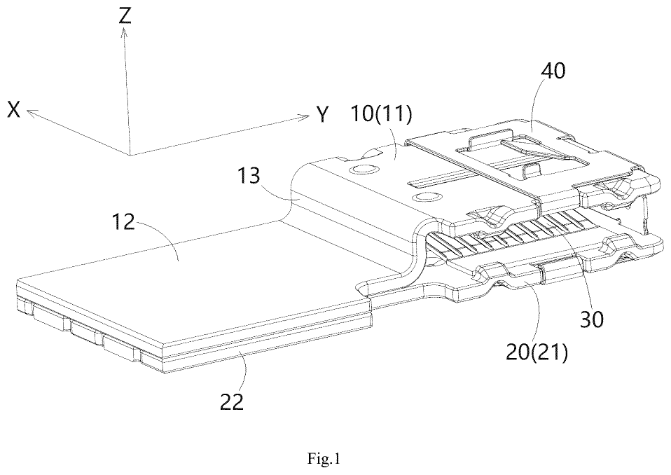

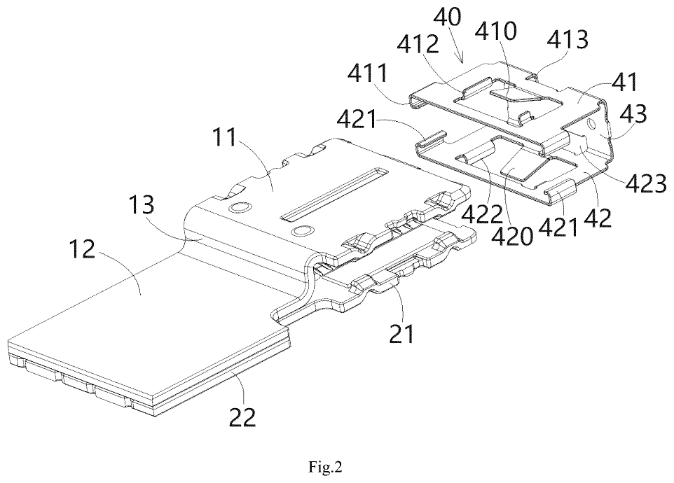

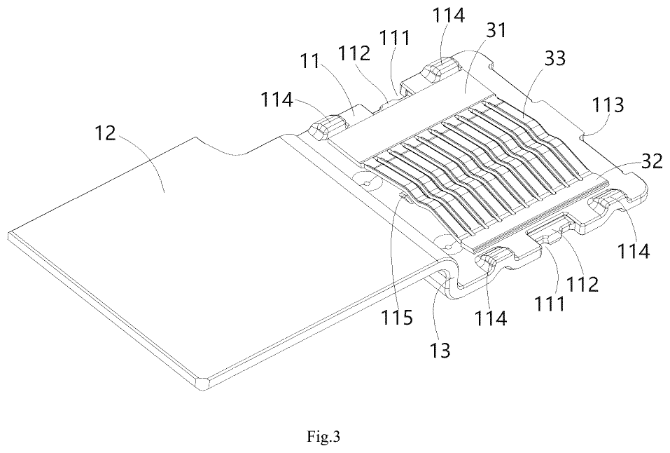

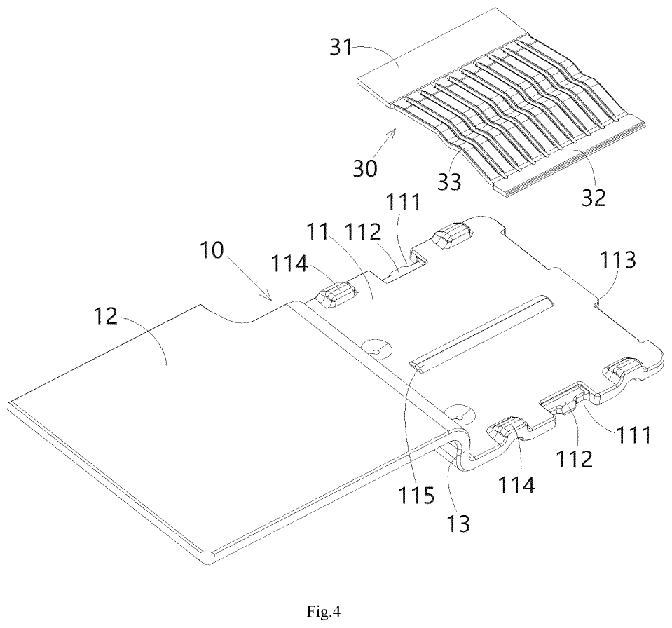

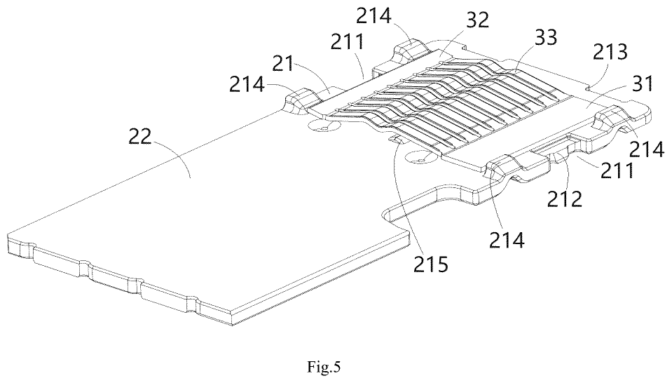

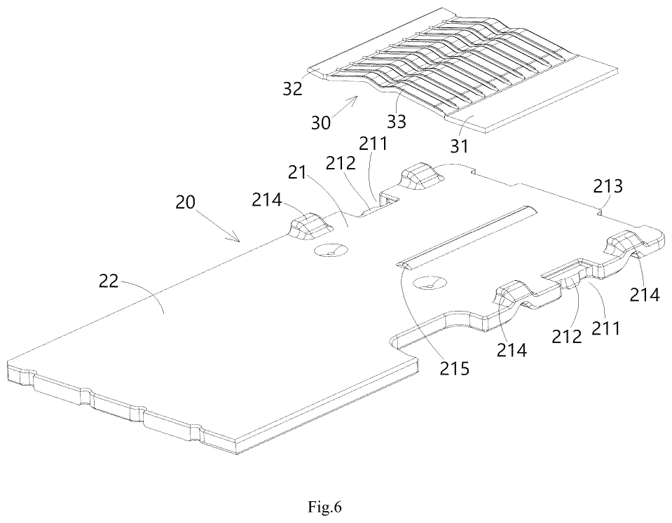

FIG. 1 shows an illustrative perspective view of a terminal according to an exemplary embodiment of the present disclosure. FIG. 2 shows an illustrative exploded view according to an exemplary embodiment of the present disclosure. FIG. 3 shows an illustrative assembly view of the first terminal plate and one elastic contact according to an exemplary embodiment of the present disclosure. FIG. 4 shows an illustrative exploded view of the first terminal plate and one elastic contact according to an exemplary embodiment of the present disclosure. FIG. 5 shows an illustrative assembly view of a second terminal plate and the other elastic contact according to an exemplary embodiment of the present disclosure. FIG. 6 shows a schematic diagram of the disassembly of the second terminal plate and the other elastic contact according to an exemplary embodiment of the present disclosure.

As shown in FIGS. 1-6, in an exemplary embodiment of the present disclosure, a terminal body is disclosed. The terminal body includes a first terminal plate 10 and a second terminal plate 20. The first terminal plate 10 includes a first mating part 11 and a first welding part 12 connected to the first mating part 11. The second terminal plate 20 includes a second mating part 21 and a second welding part 22 connected to the second mating part 21. The first mating part 11 and the second mating part 21 are spaced relative to each other in the height direction Z of the terminal body to allow a mating terminal (not shown) to be inserted. The first welding part 12 is stacked on the second welding part 22 and welded together. The first terminal plate 10 and the second terminal plate 20 are two independent components formed separately.

The first mating part 11 and the first welding part 12 are flat-shaped and oriented perpendicular to the height direction Z of the terminal body. The first terminal plate 10 also includes a bending part 13 connected between the first mating part 11 and the first welding part 12. The bending part 13 is bent at or about 90 degrees relative to the first mating part 11 and the first welding part 12, so that the first welding part 12 and the first welding part 12 are arranged at different heights.

The second mating part 21 and the second welding part 22 are in a flat shape and perpendicular to the height direction Z of the terminal body. The second mating part 21 and the second welding part 22 are at the same height. In this way, the entire second terminal plate 20 is in a flat shape.

The first terminal plate 10 has a front end and a rear end opposite to each other in the longitudinal direction Y of the terminal body, with the first mating part 11 and the first welding part 12 located at the front end and rear end of the first terminal plate 10, respectively. The second terminal plate 20 has front and rear ends opposite to each other in the longitudinal direction Y of the terminal body. The second mating part 21 and the second welding part 22 are respectively located at the front and rear ends of the second terminal plate 20. An insertion port is defined between the first mating part 11 and the second mating part 21 that allows the mating terminal to be inserted along the transverse direction X of the terminal body.

The first terminal plate 10 is an integral aluminum stamped component or an integral aluminum alloy stamped component. The second terminal plate 20 is an integral aluminum stamped component or an integral aluminum alloy stamped component. However, embodiments of the present disclosure are not limited to such material, method of manufacture, and/or construction.

In another exemplary embodiment of the present disclosure, a terminal is also disclosed. The terminal include: the aforementioned terminal body and a pair of elastic contacts 30. The pair of elastic contacts 30 are respectively installed on the inner surfaces facing each other of the first mating part 11 and the second mating part 21. The pair of elastic contacts 30 are adapted to clamp a mating terminal inserted between them, and achieve electrical connection between the terminal and the mating terminal.

In the illustrated embodiments, the elastic contact 30 comprises a first side edge part 31, a second side edge part 32, and an elastic contact arm 33. The first side edge part 31 extends along the longitudinal direction Y of the terminal body. The second side edge part 32 extends along the longitudinal Y of the terminal body and is separated from the first side edge part 31 on the transverse X of the terminal body. The elastic contact arm 33 is connected between the first side edge part 31 and the second side edge part 32. The elastic contact arm 33 is used to establish electrical contact with the inserted mating terminal to achieve electrical connection between the terminal and the mating terminal. In one embodiment, the elastic contact 30 comprises multiple elastic contact arms 33 arranged in a row along the longitudinal direction Y of the terminal body for simultaneous electrical contact with the inserted mating terminal. The first side edge parts 31 of the pair of elastic contacts 30 are fixed to the inner surfaces of the first mating part 11 and the second mating part 21, respectively. The second side edge parts 32 of the pair of elastic contacts 30 are slidably supported on the inner surfaces of the first mating part 11 and the second mating part 21, respectively.

The first mating part 11 have two sides opposite to each other in a transverse direction X of the terminal body. A pair of first protrusions 114 are formed on the inner surface of the first mating part 11 and respectively located at two sides of the first mating part 11. This supports the mating terminal inserted between the pair of elastic contacts 30, and prevents the elastic contact arm 33 from being excessively compressed by the mating terminal. The second mating part 21 have two sides opposite to each other in the transverse direction X of the terminal body. A pair of second protrusions 214 are formed on the inner surface of the second mating part 21 and respectively located at two sides of second mating part 21. This supports the mating terminal inserted between the pair of elastic contacts 30, and prevents the elastic contact arm 33 from being excessively compressed by the mating terminal.

In one embodiment, a first rib 115 is formed on the inner surface of the first mating part 11. The first rib 115 extends along the longitudinal direction Y of the terminal body to support the elastic contact arm 33 of one elastic contact 30, in order to prevent excessive deformation of the elastic contact arm 33 of one elastic contact 30. A second rib 215 is formed on the inner surface of the second mating part 21, which extends along the longitudinal direction Y of the terminal body to support the elastic contact arm 33 of the other elastic contact 30. The second rib 215 is adapted to prevent excessive deformation of the elastic contact arm 33 of the other elastic contact 30.

As shown in FIGS. 1 to 6, in the illustrated embodiments, the terminal further comprises a locking member 40, which is mounted on the ends of the first mating part 11 and the second mating part 21 to lock the terminal into the connector housing (not shown). The locking member 40 comprises a top plate 41, a bottom plate 42, and an end plate 43. The top plate 41 is fixed to the outer side of the first mating part 11. The bottom plate 42 is fixed to the outer side of the second mating part 21. The end plate 43 is connected between the top plate 41 and the bottom plate 42. The end plate 43 is fixed to the ends of the first mating part 11 and the second mating part 21.

The first mating part 11 has two side edges opposite to each other in the transverse direction X of the terminal body. A first positioning slot 111 and a first limiting tongue 112 extending into the first positioning slot 111 are formed on each of two side edges of the first mating part 11. A first elastic clamping part 411 is formed on the side of the top plate 41 of the locking member 40, which is bent inward into a C-shaped shape. The first elastic clamping part 411 is positioned in the first positioning slot 111 and grips the first limiting tongue 112.

The second mating part 21 has two side edges opposite to each other in the transverse direction X of the terminal body. A second positioning slot 211 and a second limiting tongue 212 extending into the second positioning slot 211 are formed on each of two side edges of the second mating part 21. A second elastic clamping part 421 is formed on the side of the bottom plate 42 of the locking member 40, which is bent inward into a C-shaped shape. The second elastic clamping part 421 is positioned in the second positioning slot 211 and grips the second limiting tongue 212.

A first elastic locking piece 410 and a second elastic locking piece 420 are respectively formed on the top plate 41 and bottom plate 42 of the locking member 40. The first elastic locking piece 410 and the second elastic locking piece 420 are used to engage with the connector housing to lock the terminal in the connector housing. Further, a first guide rib 412 and a second guide rib 422 are formed on the outside of the top plate 41 and bottom plate 42 of the locking member 40, respectively. The first guide rib 412 and the second guide rib 422 are used to mate with a first guide slot and a second guide slot in the connector housing to guide the terminal to be inserted into the connector housing.

A positioning protrusion 113 and a second positioning protrusion 213 are formed on the end faces of the first mating part 11 and the second mating part 21, respectively. A first positioning slot hole 413 and a second positioning slot hole 423 are formed in the end plate 43 of the locking member 40. The first positioning protrusion 113 and the second positioning protrusion 213 are fitted into the first positioning slot hole 413 and the second positioning slot hole 423, respectively.

In another exemplary embodiment of the present disclosure, a connector is provided. The connector includes a connector housing and the aforementioned terminal. The terminal is inserted into the connector housing.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are

intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A terminal body, comprising:
a first terminal plate including a first mating part and a first welding part connected to the first mating part; and
a second terminal plate including a second mating part and a second welding part connected to the second mating part, the first mating part and the second mating part are spaced relative to each other in a height direction of the terminal body and adapted to permit insertion of a mating terminal, the first welding part is stacked and welded on the second welding part.

2. The terminal body according to claim 1, wherein the first terminal plate and the second terminal plate are independent components formed separately.

3. The terminal body according to claim 1, wherein the first mating part and the first welding part are flat-shaped and oriented perpendicular to the height direction of the terminal body.

4. The terminal body according to claim 1, wherein the first terminal plate further comprises a bending part connected between the first mating part and the first welding part, the bending part oriented normal to the first mating part and the first welding part, so that the first mating part is at a different height from the first welding part.

5. The terminal body according to claim 1, wherein the second mating part and the second welding part are flat-shaped and oriented perpendicular to the height direction of the terminal body, the second mating part and the second welding part are arranged at the same height such that the entire second terminal plate is in flat-shaped.

6. The terminal body according to claim 5, wherein:
the first terminal plate has a front end and a rear end opposite to each other in a longitudinal direction of the terminal body, and the first mating part and the first welding part are respectively located at the front end and rear end of the first terminal plate; and
the second terminal plate has a front end and a rear end opposite to each other in the longitudinal direction of the terminal body, and the second mating part and the second welding part are respectively located at the front end and rear end of the second terminal plate.

7. The terminal body according to claim 1, the first and second terminal plates are integral aluminum stamped components or an integral aluminum alloy stamped components.

8. A terminal, comprising:
a terminal body, including:
a first terminal plate including a first mating part and a first welding part connected to the first mating part; and
a second terminal plate including a second mating part and a second welding part connected to the second mating part, the first mating part and the second mating part are spaced relative to each other in a height direction of the terminal body and adapted to permit insertion of a mating terminal, the first welding part is stacked and welded on the second welding part; and
a pair of elastic contacts installed on inner opposed surfaces of the first mating part and the second mating part, respectively, the pair of elastic contacts are adapted to clamp the mating terminal inserted between therebetween to achieve electrical connection between the terminal and the mating terminal.

9. The terminal according to claim 8, wherein the elastic contact is adapted to establish electrical contact with the inserted mating terminal to achieve electrical connection between the terminal and the mating terminal, and includes:
a first side edge part extending along the longitudinal direction of the terminal body;
a second side edge part extending along the longitudinal direction of the terminal body; and
an elastic contact arm connected between the first side edge part and the second side edge part, the elastic contact arm is.

10. The terminal according to claim 9, wherein the elastic contact further includes multiple elastic contact arms arranged in a row along the longitudinal direction of the terminal body for establishing simultaneous electrical contact with the inserted mating terminal.

11. The terminal according to claim 9, wherein:
the first side edge parts of the pair of elastic contacts are fixed to inner surfaces of the first mating part and the second mating part, respectively;
the second side edge parts of the pair of elastic contacts are slidably supported on the inner surfaces of the first mating part and the second mating part, respectively.

12. The terminal according to claim 9, wherein:
the first mating part has two sides opposite to each other in a transverse direction of the terminal body, and a pair of first protrusions are formed on the inner surface of the first mating part and respectively located at the two sides of the first mating part, to support the mating terminal inserted between the pair of elastic contacts, to prevent the elastic contact arm from being excessively compressed by the mating terminal;
the second mating part has two sides opposite to each other in the transverse direction of the terminal body, and a pair of second protrusions are formed on the inner surface of the second mating part and respectively located at the two sides of the second mating part, to support the mating terminal inserted between the pair of elastic contacts, to prevent the elastic contact arm from being excessively compressed by the mating terminal.

13. The terminal according to claim 9, wherein:
a first rib is formed on an inner surface of the first mating part and extends along the longitudinal direction of the terminal body to support the elastic contact arm of one elastic contact, to prevent excessive deformation of the elastic contact arm of the one elastic contact; and
a second rib is formed on an inner surface of the second mating part and extends along the longitudinal direction of the terminal body to support the elastic contact arm of the other elastic contact, to prevent excessive deformation of the elastic contact arm of the other elastic contact.

14. The terminal according to claim 8, further comprising a locking member selectively fitted on ends of the first mating part and the second mating part and locking the terminal into a connector housing.

15. The terminal according to claim 14, wherein the locking member includes:
a top plate fixed to an outer side of the first mating part;
a bottom plate fixed to an outer side of the second mating part; and
an end plate connected between the top plate and the bottom plate, and fixed to the ends of the first mating part and the second mating part.

16. The terminal according to claim 15, wherein:
the first mating part has two side edges opposite to each other in the transverse direction of the terminal body, and a first positioning slot and a first limiting tongue extending into the first positioning slot are formed on each side edge of the first mating part; and
a first elastic clamping part bent inward into a C-shape is formed on the side of the top plate of the locking member, and the first elastic clamping part is positioned in the first positioning slot and clamps the first limiting tongue.

17. The terminal according to claim 15, wherein:
the second mating part has two side edges opposite to each other in the transverse direction of the terminal body, and a second positioning slot and a second limiting tongue extending into the second positioning slot are formed on each side edge of the second mating part;
a second elastic clamping part bent inward into a C-shape is formed on the side of the bottom plate of the locking member, and the second elastic clamping part is positioned in the second positioning slot and clamps the second limiting tongue.

18. The terminal according to claim 15, wherein a first elastic locking piece and a second elastic locking piece are respectively formed on the top plate and bottom plate of the locking member, the first elastic locking piece and the second elastic locking piece are adapted engage with the connector housing to lock the terminal in the connector housing.

19. The terminal according to claim 15, wherein a first guide rib and a second guide rib are respectively formed on the outsides of the top plate and the bottom plate of the locking member, the first guide rib and the second guide rib are used to respectively cooperate with a first guide slot and a second guide slot on the connector housing, to guide the terminal to be inserted into the connector housing.

20. The terminal according to claim 15, wherein a first positioning protrusion and a second positioning protrusion are respectively formed on the end faces of the first mating part and the second mating part, and a first positioning slot hole and a second positioning slot hole are respectively formed in the end plate of the locking member, the first positioning protrusion and the second positioning protrusion are respectively fitted into the first positioning slot hole and the second positioning slot hole.
